(19) United States
(12) Patent Application Publication
(10) Pub. No.: US 2008/0186668 A1
(43) Pub. Date: Aug. 7, 2008

(54) ACOUSTIC NOISE SUPPRESSION DEVICE

(75) Inventors: Naufel C. Naufel, Tempe, AZ (US); Fernando Fernandez, Chandler, AZ (US); David R. Maggart, Tempe, AZ (US)

Correspondence Address: MOTOROLA, INC., LAW DEPARTMENT, 1303 E. ALGONQUIN ROAD, SCHAUMBURG, IL, 60196, US

(73) Assignee: MOTOROLA, INC., Schaumburg, IL (US)

(21) Appl. No.: 11/672,113

(22) Filed: Feb. 7, 2007

(51) Int. Cl. G06F 1/20

(52) U.S. Cl. 361/687; 361/695

(57) ABSTRACT

An acoustic noise suppression device may include exhaust chambers adapted to interface with at least one exhaust port of an embedded computer chassis, where the exhaust port passes cooling air from at least one exhaust fan; a v-shaped deflector adapted to divide and direct the cooling air to the plurality of exhaust chambers; and noise suppression media coupled to the plurality of exhaust chambers, where the noise suppression media modifies a flow vector of the cooling air, and where the acoustic noise suppression device decreases a sound level created by the at least one exhaust fan.

### BACKGROUND OF INVENTION

Rack-mounted embedded computer chassis are generally cooled using fan modules containing any number of cooling fans. As processor speeds increase, cooling requirements for the chassis increase, with a corresponding increase in the number and/or speed of the cooling fans. As the number of fans increase, or the fan speed increases, the noise created by the fan modules increases, creating an unacceptably high noise level. The prior art is deficient in providing a means for suppressing the noise created by the cooling fans. There is a need, not met in the prior art, of an acoustic noise suppression device for an embedded computer chassis.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates a rack-mounted computer system in accordance with an exemplary embodiment of the present invention;

FIG. 2 representatively illustrates a portion of the rack-mounted computer system in accordance with an exemplary embodiment of the present invention;

FIG. 3 representatively illustrates an embedded computer chassis in accordance with an exemplary embodiment of the present invention;

FIG. 4 representatively illustrates an embedded computer chassis having an acoustic noise suppression device in accordance with an exemplary embodiment of the present invention;

FIG. 5 representatively illustrates the rack-mounted computer system in accordance with an exemplary embodiment of the present invention;

FIG. 6 representatively illustrates an acoustic noise suppression device in accordance with an exemplary embodiment of the present invention;

FIGS. 7 and 8 representatively illustrates isometric views of an acoustic noise suppression device in accordance with an exemplary embodiment of the present invention; and

FIG. 9 representatively illustrates an internal view of an acoustic noise suppression device in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter a/ia for distinguishing between similar elements and not necessarily for describing a sequential or chronological order. Moreover, the terms “front”, “aback”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

The terms “a” or “an”, as used herein, are defined as one, or more than one. The term “plurality,” as used herein, is defined as two, or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

A detailed description of an exemplary application is provided as a specific enabling disclosure that may be generalized to any application of the disclosed system, device in accordance with various embodiments of the present invention.

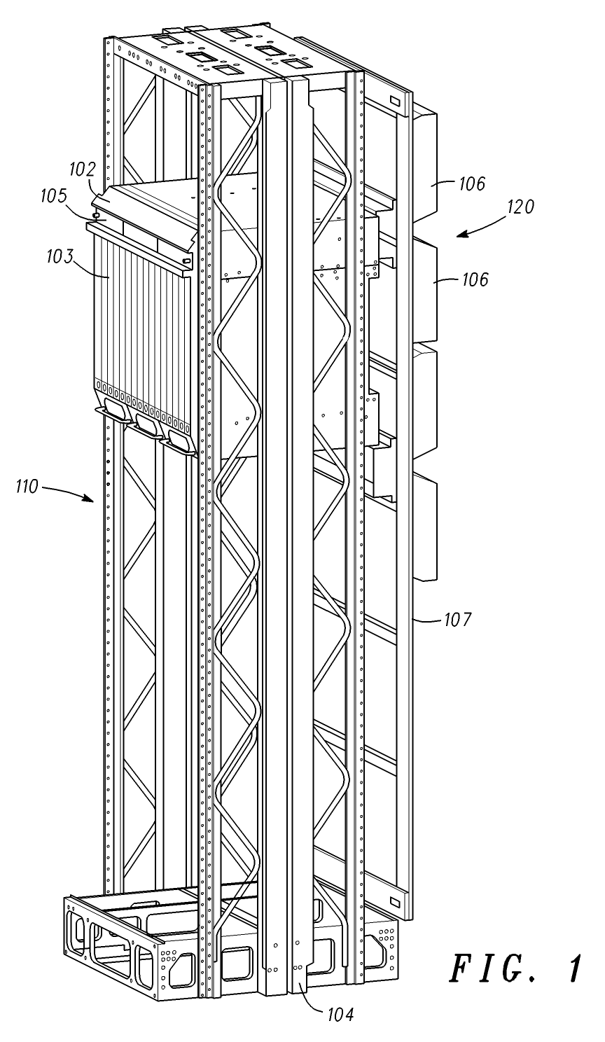

FIG. 1 representatively illustrates a rack-mounted computer system 100 in accordance with an exemplary embodiment of the present invention. Rack-mounted computer system 100 may include an embedded computer chassis 102 having a front side 110 and a back side 120.

Rack-mounted computer system 100 includes computer frame 104, in which embedded computer chassis 102 can be mounted. Computer frame 104 is known in the art and can be used in any application requiring modular computing resources, for example and without limitation, telecommunications, industrial control, system control and data acquisition (SCADA), and the like. An example, computer frame 104 including dimensions, and the like, may be set forth in the American National Standards Institute/Electronic Industries Association (ANSI/EIA) specification 310, published by EIA Engineering Department, 2001 Pennsylvania Ave. N.W., Washington D.C. 20006. Another example, computer frame 104 including dimensions, and the like, is set forth in the European Telecommunications Standard for equipment practice Part 3: Engineering requirements for miscellaneous chassis and cabinets (ETS 300 119-3), as published by European Telecommunication Standards Institute (ETSI), 650 Route des Lucioles, Sophia Antipolis, Valbonne, France. The invention is not limited to computer frames and embedded computer chassis in the above specifications and can include any computer frame designed to support embedded computer chassis and be within the scope of the invention.

Embedded computer chassis 102 can be used in any application requiring modular, embedded computing resources, for example and without limitation, telecommunications, industrial control, system control and data acquisition (SCADA), and the like. In the exemplary embodiment depicted in FIG.1, embedded computer chassis 102 can be a 6U chassis, which may refer to the height, thickness, number of slots, and the like, of the embedded computer chassis 102. 6U modules can be coupled together and “stacked” (vertically or horizontally) to form a distributed computing system adapted to share resources.

As is known in the art, “U” and multiples of “U” can refer to both the width or height (depending if orientation is horizontal or vertical) of a module and/or the width or height of the embedded computer chassis 102. In an embodiment, “U” can measure approximately 1.75 inches. The invention is not limited to a 6U chassis or modules Any size chassis or modules, for example 3U, 5U, 9U, 10U, and the like, are within the scope of the invention. The “U” terminology is not limiting of the invention. As such, the invention is not limited to “U” as a form factor reference. Other form factor reference notations and increments are within the scope of the invention.

In an embodiment, rack-mounted computer system 100 and embedded computer chassis 102 may comply with the Advanced Telecom and Computing Architecture (ATCA™) standard as defined in the PICMG 3.0 AdvancedTCA specification. In another embodiment, rack-mounted computer system 100 and embedded computer chassis 102 may comply with CompactPCI™ standard. In yet another embodiment, rack-mounted computer system 100 and embedded computer chassis 102 may comply with VERSAmodule Eurocard (VMEbus) standard. In still another embodiment, rack-mounted computer system 100 and embedded computer chassis 102 may comply with VMEbus switched serial standard backplane (VXS) as set forth in VITA 41 promulgated by VMEbus International Trade Association (VITA), P.O. Box 19658, Fountain Hills, Ariz., 85269. VXS network includes a switched fabric and a VMEbus network, both located on backplane. The embodiment of the invention is not limited to the use of these standards, and the use of other standards is within the scope of the invention.

Embedded computer chassis 102 may be comprised of a series of computing modules 103 and fan modules 105. Embedded computer chassis 102 may include a plurality of slots for inserting computing modules 103, for example payload modules and switch modules. Computing modules 103 may couple to a backplane (not shown for clarity) to facilitate power distribution and/or communication using a bus topology, switch fabric topology, and the like. In an embodiment, backplane may comprise for example and without limitation, 100-ohm differential signaling pairs. When in operation, computing modules 103 generate heat that must be removed from embedded computer chassis 102.

Payload modules may add functionality to embedded computer chassis 102 through the addition of processors, memory, storage devices, I/O elements, and the like. In other words, payload module may include any combination of processors, memory, storage devices, I/O elements, and the like, to give embedded computer chassis 102 any functionality desired by a user.

In an embodiment, a switch module may be used as a central switching hub with any number of payload modules coupled to one or more switch modules.

Embedded computer chassis 102 may support a point-to-point, switched input/output (I/O) fabric. Switched fabric can be based on a point-to-point, switched input/output (I/O) fabric, whereby cascaded switch devices interconnect end node devices. In an embodiment, switched fabric can be configured as a star topology, mesh topology, and the like as known in the art for communicatively coupling switched fabrics. Switched fabric can include both module-to-module (for example computer systems that support I/O module add-in slots) and chassis-to-chassis environments (for example interconnecting computers, external storage systems, external Local Area Network (LAN) and Wide Area Network (WAN) access devices in a data-center environment).

Switched fabric may be implemented by using one or more of a plurality of switched fabric network standards, for example and without limitation, InfiniBand™, Serial Rapid IO™, Ethernet™, AdvancedTCA™, PCI Express™, Gigabit Ethernet, and the like. Embodiments of the invention are not limited to the use of these switched fabric network standards and the use of any switched fabric network standard is within the scope of the invention.

In an embodiment, fan module 105 may be adjacent to computing modules 103. One or more fan modules 103 are disposed to draw cooling air over computing modules 103. In an embodiment, each fan module 105 may include one or more exhaust fans, power and control circuitry, and the like. Fan modules 105 may plug into a fan module bay and receive power from a central or dedicated power supply for embedded computer chassis 102.

In an embodiment, computer system 100 may include acoustic noise suppression device 106 coupled to frame door 107 of computer frame 104 as discussed more fully below.

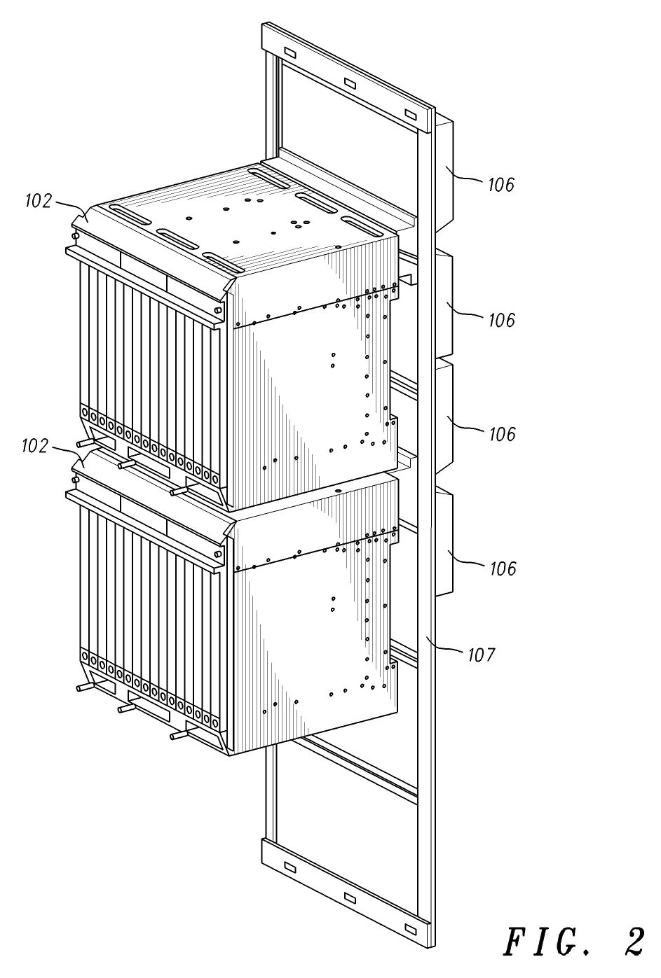

FIG. 2 representatively illustrates a portion of the rack-mounted computer system 100 in accordance with an exemplary embodiment of the present invention. FIG. 2 illustrates embedded computer chassis 102 along with frame door 107 of computer frame 104. Acoustic noise suppression device 106 for each embedded computer chassis are shown mounted to frame door 107. Each acoustic noise suppression device 106, although mounted to frame door 107, is adapted to interface with embedded computer chassis 102 to reduce acoustic noise created by at least one exhaust fan.

FIG. 3 representatively illustrates an embedded computer chassis 102 in accordance with an exemplary embodiment of the present invention. Embedded computer chassis 102 is shown in an isometric view from the back side 120, which faces frame door 107 as shown in FIGS. 1 and 2.

Embedded computer chassis 102 includes one or more fan modules 105, and one or more fan exhaust ports 108. Each fan module 105 may include one or more exhaust fans, blowers, and the like. In general, cooling air 109 is drawn into embedded computer chassis 102, over computing modules 103 and exhausted out the back side 120 through exhaust ports 108, thereby removing heat from embedded computer chassis 102.

Fan modules 105 may be configured in any combination of “push” or “pull” patterns. In other words, fan modules 105 can either “push” cooling air 109 over computing modules 103, “pull” cooling air 109 over computing modules 103, or any combination thereof. In pushing or pulling cooling air 109 over computing modules 103, cooling air 109 can flow over one or both sides of computing modules 103. As an example of an embodiment, fan modules 105 can include one or more muffin fans. The number and operating point of fan modules 105 can be chosen to fit a particular application and is well within the abilities of one of ordinary skill in the art.

When cooling air 109 exits exhaust ports 108, it has a general direction and velocity, in other words, cooling air has a flow vector 111 associated with it when it exits embedded computer chassis. In an embodiment, cooling air 109 may have a flow vector 111 substantially perpendicular to the back side 120 of embedded computer chassis 102 upon exit.

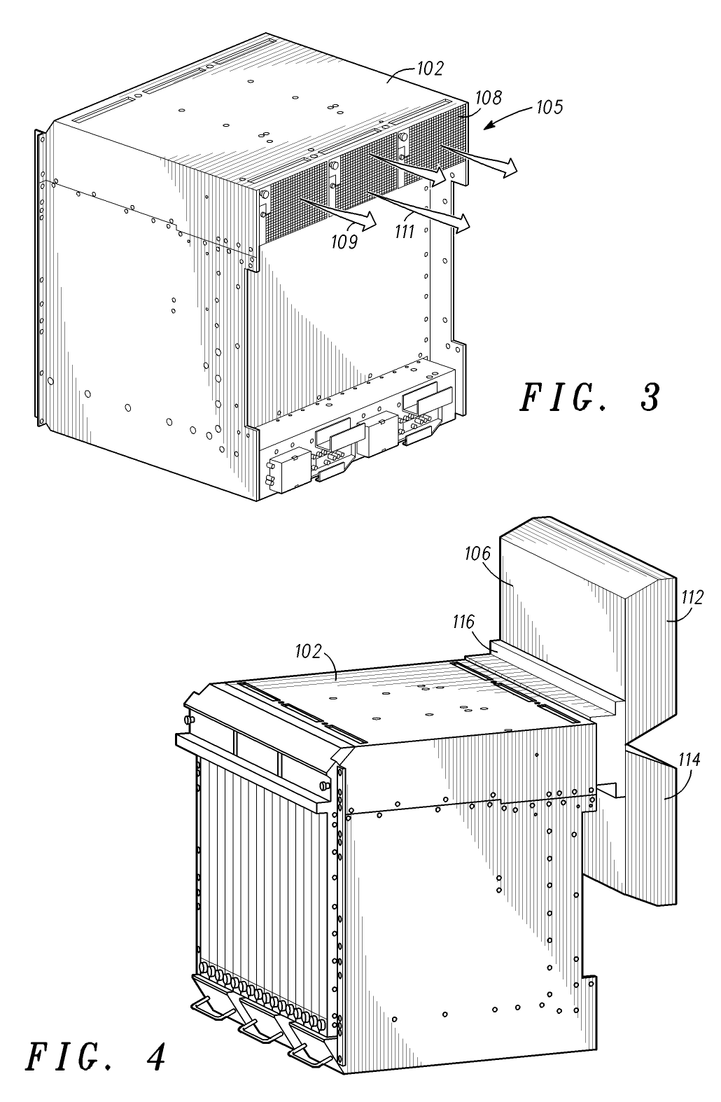

FIG. 4 representatively illustrates an embedded computer chassis 102 having an acoustic noise suppression device 106 in accordance with an exemplary embodiment of the present invention. Embedded computer chassis 102 is shown in an isometric view from the front side 110.

As discussed above, exhaust fans in fan modules 105 generate noise that may be unacceptable in any number of applications. In an embodiment, acoustic noise suppression device 106 may be adapted to interface with embedded computer chassis 102 to reduce the sound level (in decibels (dB)). FIG. 4 shows acoustic noise suppression device coupled to embedded computer chassis 102. In one embodiment, acoustic noise suppression device 106 may be coupled to frame door 107 of computer frame 104 and interface with embedded computer chassis 102 when frame door 107 is in the “closed” position. In another embodiment, acoustic noise suppression device 106 may be coupled directly to embedded computer chassis 102.

FIG. 4 shows acoustic noise suppression device 106 interfaced with embedded computer chassis 102 and omits frame door 107 for clarity. In an embodiment, acoustic noise suppression device 106 may include a an entry chamber 116 and a plurality of exhaust chambers, for example, a first exhaust chamber 112 and a second exhaust chamber 114. Entry chamber 116 is adapted to interface with exhaust ports 108 to receive cooling air 109 as it exits embedded computer chassis 102. Acoustic noise suppression device 106 is adapted to distribute cooling air 109 through plurality of exhaust chambers 112, 114, thereby decreasing the sound level of one or more exhaust fans (as perceived by a user external to embedded computer chassis 102).

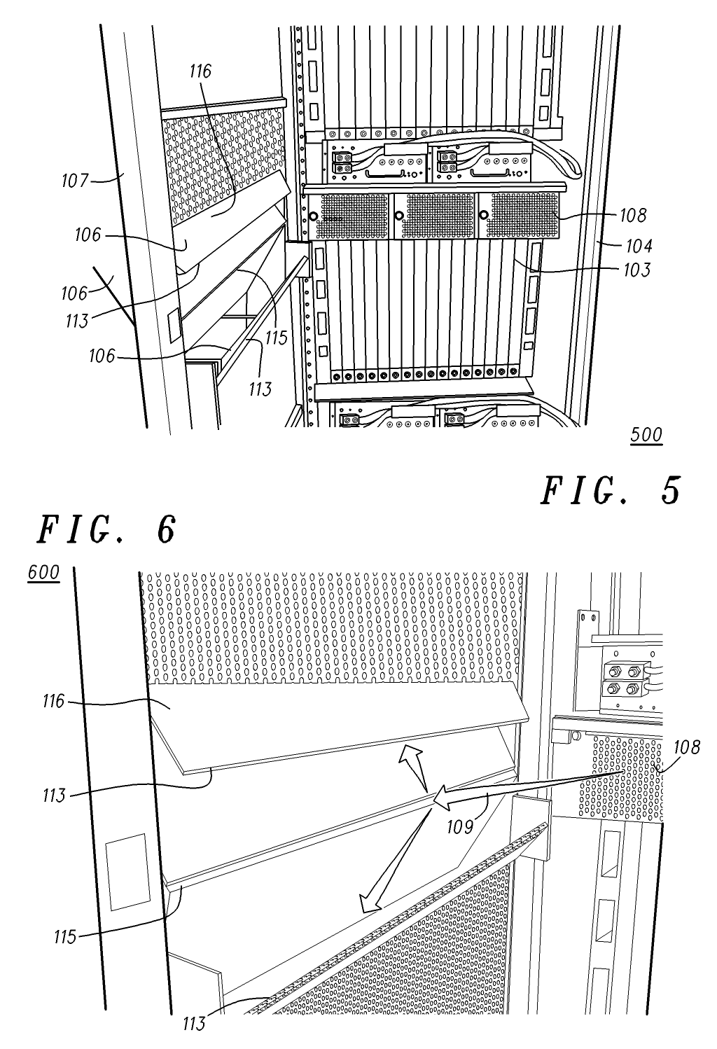

FIG. 5 representatively illustrates the rack-mounted computer system 500 in accordance with an exemplary embodiment of the present invention. In FIG. 5, rack-mounted computer system 500 is shown from the back side 120 with the frame door 107 in an “open” position.

Embedded computer chassis 102, along with computing modules 103 are shown mounted in computer frame 104. Exhaust ports 108 are also shown. In this embodiment, acoustic noise suppression device 106 is mounted to frame door 107. Entry chamber 116 is coupled to inside of frame door 107 so as to interface with exhaust ports 108 when frame door 107 is moved to the “closed” position. Plurality of exhaust chambers are shown mounted to the outside face of frame door 107. This is not limiting of the invention as entry chamber 116 and plurality of exhaust chambers may be coupled to any combination of the inside and outside faces of frame door 107.

In an embodiment, entry chamber 116 may include an elastic seal 113 that is adapted to interface with exhaust ports 108. When frame door 107 is in the “closed” position, elastic seal 113 may operate to ensure that substantially all of the cooling air is channeled from the exhaust ports 108 to the entry chamber 116.

In an embodiment, acoustic noise suppression device 106 may include a v-shaped deflector 115 adapted to divide and direct cooling air to the first exhaust chamber and the second exhaust chamber.

FIG. 6 representatively illustrates an acoustic noise suppression device 106 in accordance with an exemplary embodiment of the present invention. FIG. 6 illustrates a closer view of entry chamber 116 of acoustic noise suppression device 106.

Elastic seal 113 may be coupled to one or more edges of entry chamber 116 such that when frame door 107 is in the “closed” position, substantially all of the cooling air 109 is channeled to the acoustic noise suppression device 106. Elastic seal 113 may be neoprene, rubber, or any other flexible material such that when frame door 107 is closed, elastic seal 113 molds itself around the periphery of the exhaust ports 108 to channel substantially all of the cooling air 109 to the acoustic noise suppression device 106.

In an embodiment, v-shaped deflector 115 divides and directs cooling air 109 from exhaust ports 108 to plurality of exhaust chambers. In the embodiment shown, v-shaped deflector 115 splits cooling air into two substantially equal air streams and channels each of these streams into an exhaust chamber. In an embodiment, v-shaped deflector 115 may be configured to channel cooling air 109 unequally, equally, and the like, to any number of exhaust chambers. In the embodiment shown, v-shaped deflector 115 takes cooling air 109 exiting substantially perpendicular to the back side 120 of embedded computer chassis 102, and diverts it at an angle of less than ninety degrees into each exhaust chamber. V-shaped deflector 115 may be configured so as to minimize head loss and back pressure in the cooling air 109 to fit any desired configuration of exhaust ports and cooling air volume.

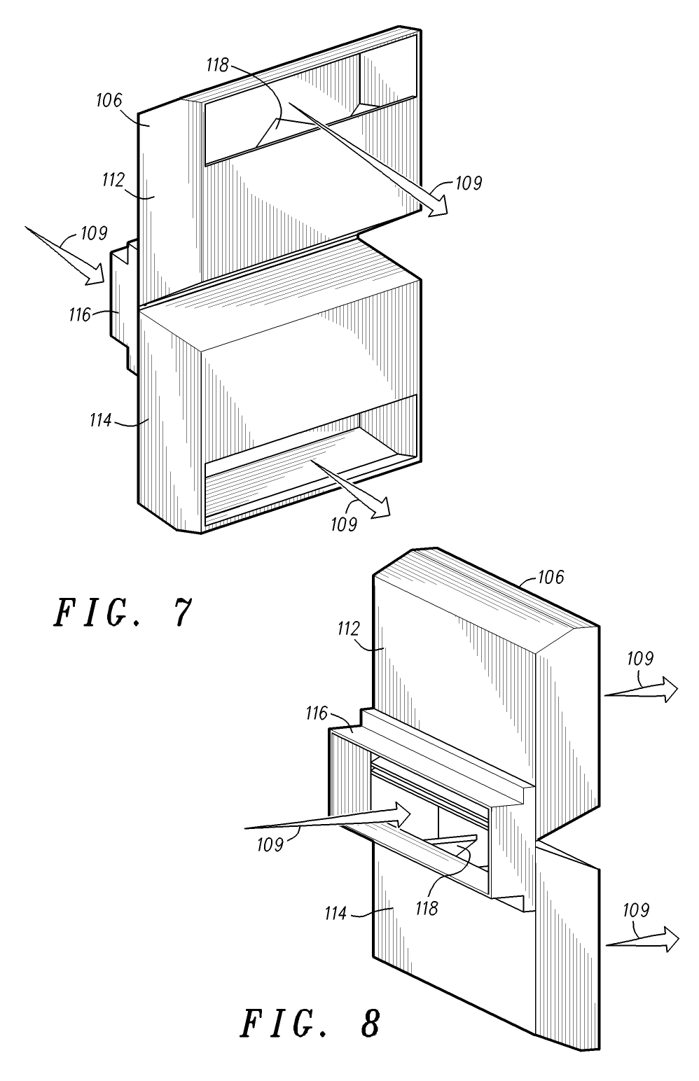

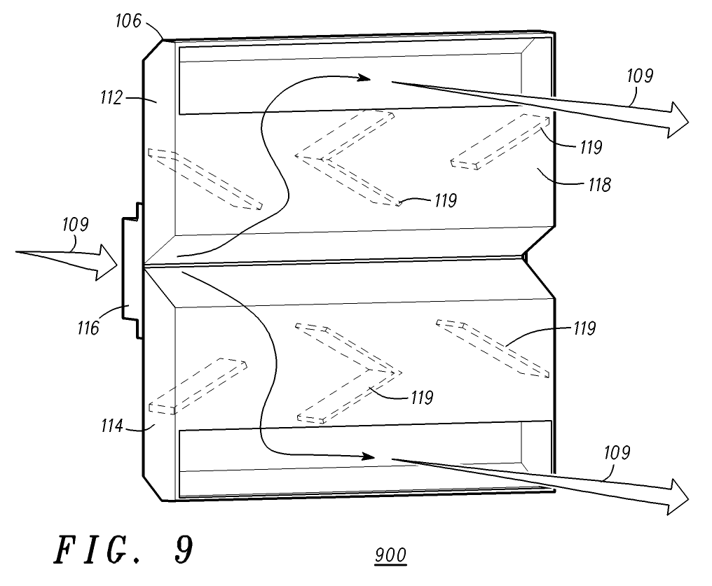

FIGS. 7 and 8 representatively illustrates isometric views of an acoustic noise suppression device 106 in accordance with an exemplary embodiment of the present invention. In the configuration show, acoustic noise suppression device 106 includes first exhaust chamber 112 and second exhaust chamber 114. The invention is not limited to two exhaust chambers, and acoustic noise suppression device 106 may have any number of exhaust chambers and be within the scope of the invention.

In an embodiment, each of first exhaust chamber 112 and second exhaust chamber 114 comprise noise suppression media 118. Noise suppression media 118 may operate to change the flow vector 111 of the cooing air 109. In other words, noise suppression media 118 may change the direction, velocity or both of the cooling air 109 such that the sound level of the exhaust fans is reduced (as perceived externally to the embedded computer chassis).

Cooling air 109 enters entry chamber 116 from one or more exhaust ports 108. Cooling air 109 may be directed and divided into each of first exhaust chamber 112 and second exhaust chamber 114 and through noise suppression media 118. Cooling air 109 may exit the first exhaust chamber 112 and second exhaust chamber 114 from any angle. In the embodiment shown, cooling air 109 exits the exhaust chambers substantially perpendicular to back side 120. This is not limiting of the invention, and cooling air 109 may exit the exhaust chambers from any angle and in any direction and be within the scope of the invention.

In an embodiment, noise suppression media 118 may include any material, arrangement of geometric shapes, or any combination thereof, that decreases the sound level between the entry chamber and the exhaust of the first exhaust chamber 112 and second exhaust chamber 114. For example, noise suppression media may include sound reflecting material, sound absorbing material, or any combination thereof. Sound reflecting material has a relatively low sound absorption coefficient (approximately less than 0.5), compared to sound absorbing material that has a relatively high sound absorption coefficient (approximately greater than 0.5).

Generally, sound reflective materials are non-porous and relatively impervious. On the other hand, sound absorbing materials are generally porous, lightweight materials. Examples of sound absorbing materials may include, but are not limited to: formed, matted or spun fibers, panel absorbers having a relatively impervious surface mounted over an airspace, resonators (created by holes or slots connected to an enclosed volume of trapped air). Other materials may include cellulose, aerated plaster, fibrous mineral wool and glass fiber, open-cell foam, felted or cast porous ceiling tile, and the like. Many other materials may occur to one of ordinary skill in the art and are within the scope of the invention.

Noise suppression media 118 may include any combination of geometric shapes, such as pyramids, cones, cylinders, blocks, and the like, constructed out of reflective and/or sound absorbing materials. These shapes may be arranged to force a serpentine path for the cooling air 109, thereby modifying the flow vector 111 and decreasing the sound level.

FIG. 9 representatively illustrates an internal view of an acoustic noise suppression device 106 in accordance with an exemplary embodiment of the present invention. In this embodiment, noise suppression media 118 comprises a series of baffles 119 in each of first exhaust chamber 112 and second exhaust chamber 114. Cooling air 109 enters through entry chamber 116 and is directed into each exhaust chamber via v-shaped deflector. Cooling air 109 is then directed through a series of baffles that modify the flow vector 111 of the cooling air 109. Baffles 119 may be arranged in each of first exhaust chamber 112 and second exhaust chamber 114 in any suitable manner by one skilled in the art to fit a particular application. As shown in this embodiment, cooling air 109 is directed through baffles 119, which continually modify the flow vector 111 and reduce the sound level of the exhaust fans. The baffle configuration shown is exemplary and not limiting of the invention, as other baffle configurations are within the scope of the invention.

In the foregoing specification, the invention has been described with reference to specific exemplary embodiments. However, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. An embedded computer chassis, comprising:
at least one fan exhaust port, wherein the at least one fan exhaust port is adapted to exhaust cooling air from the embedded computer chassis via at least one exhaust fan; and
an acoustic noise suppression device adapted to interface with the at least one fan exhaust port, wherein the acoustic noise suppression device decreases a sound level created by the at least one exhaust fan, and wherein the acoustic noise suppression device distributes the cooling air through a plurality of exhaust chambers.

2. The embedded computer chassis of claim 1, wherein the embedded computer chassis is selected from the group consisting of an Advanced Telecom and Computing Architecture (ATCA™) computer chassis, a CompactPCI computer chassis, and a VMEbus computer chassis.

3. The embedded computer chassis of claim 1, wherein the plurality of exhaust chambers each comprise noise suppression media, wherein the noise suppression media modifies a flow vector of the cooling air.

4. The embedded computer chassis of claim 3, wherein the noise suppression media comprises at least one baffle.

5. The embedded computer chassis of claim 3, wherein the noise suppression media comprises a porous sound-absorbing material.

6. The embedded computer chassis of claim 1, wherein the plurality of exhaust chambers comprise a first exhaust chamber and a second exhaust chamber, wherein a v-shaped deflector is adapted to divide and direct the cooling air to the first exhaust chamber and the second exhaust chamber.

7. The embedded computer chassis of claim 1, wherein an elastic seal is coupled to the acoustic noise suppression device, and wherein the elastic seal is adapted to interface with the at least one fan exhaust port.

8. A computer frame, comprising:
an embedded computer chassis coupled to the computer frame, wherein the embedded computer chassis comprises at least one fan exhaust port, wherein the at least one fan exhaust port is adapted to exhaust cooling air from the embedded computer chassis via at least one exhaust fan; and
an acoustic noise suppression device adapted to interface with the at least one fan exhaust port, wherein the acoustic noise suppression device decreases a sound level created by the at least one exhaust fan, and wherein the acoustic noise suppression device distributes the cooling air through a plurality of exhaust chambers.

9. The computer frame of claim 8, wherein the plurality of exhaust chambers each comprise noise suppression media, wherein the noise suppression media modifies a flow vector of the cooling air.

10. The computer frame of claim 9, wherein the noise suppression media comprises at least one baffle.

11. The computer frame of claim 9, wherein the noise suppression media comprises a porous sound-absorbing material.

12. The embedded computer chassis of claim 8, wherein the plurality of exhaust chambers comprise a first exhaust chamber and a second exhaust chamber, wherein a v-shaped deflector is adapted to divide and direct the cooling air to the first exhaust chamber and the second exhaust chamber.

13. The computer frame of claim 8, wherein an elastic seal is coupled to the acoustic noise suppression device, and wherein the elastic seal is adapted to interface with the at least one fan exhaust port.

14. The computer frame of claim 8, wherein the computer frame further comprises a frame door, and wherein the acoustic noise suppression device is coupled to the frame door.

15. An acoustic noise suppression device, comprising:
a plurality of exhaust chambers adapted to interface with at least one exhaust port of an embedded computer chassis, wherein the at least one exhaust port passes cooling air from at least one exhaust fan;
a v-shaped deflector adapted to divide and direct the cooling air to the plurality of exhaust chambers; and
noise suppression media coupled to the plurality of exhaust chambers, wherein the noise suppression media modifies a flow vector of the cooling air, and wherein the acoustic noise suppression device decreases a sound level created by the at least one exhaust fan.

16. The acoustic noise suppression device of claim 15, wherein the noise suppression media comprises at least one baffle.

17. The acoustic noise suppression device of claim 15, wherein the noise suppression media comprises a porous sound-absorbing material.

18. The acoustic noise suppression device of claim 15, wherein an elastic seal is coupled to the acoustic noise suppression device, and wherein the elastic seal is adapted to interface with the at least one exhaust port.

19. A method of attenuating noise generated by at least one exhaust fan of an embedded computer chassis, comprising:
providing a plurality of exhaust chambers adapted to interface with at least one exhaust port of an embedded computer chassis;
the at least one exhaust port passing cooling air from at least one exhaust fan;
a v-shaped deflector dividing and directing the cooling air to the plurality of exhaust chambers;
modifying a flow vector of the cooling air using noise suppression media coupled to the plurality of exhaust chambers; and
decreasing a sound level created by the at least one exhaust fan.

20. The method of claim 19, wherein the noise suppression media comprises at least one baffle.

21. The method of claim 19, wherein the noise suppression media comprises a porous sound-absorbing material.

22. The method of claim 19, further comprising providing an elastic seal coupled to the plurality of exhaust chambers, wherein the elastic seal is adapted to interface with the at least one fan exhaust port.
